(19) United States
(12) Patent Application Publication
(10) Pub. No.: US 2025/0031130 A1
(43) Pub. Date: Jan. 23, 2025

(54) APPLICATION OF DYNAMIC INDICATION FOR SUBBAND FULL DUPLEX

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US)

(21) Appl. No.: 18/353,686

(22) Filed: Jul. 17, 2023

(51) Int. Cl. H04W 48/08; H04W 72/0446; H04W 72/1273

(52) U.S. Cl. CPC H04W 48/08; H04W 72/0446; H04W 72/1273

(57) ABSTRACT

Various aspects of the present disclosure generally relate to wireless communication. In some aspects, a user equipment (UE) may receive a semi-static time and frequency configuration for subband full duplex (SBFD) operation in a symbol or slot pattern. The UE may receive a dynamic indication that adds or updates one or more SBFD symbols or slots in the symbol or slot pattern. The UE may communicate based at least in part on the semi-static time and frequency configuration and one or more of the dynamic indication or a restriction rule that restricts application of the dynamic indication. Numerous other aspects are described.

### FIELD OF THE DISCLOSURE

Aspects of the present disclosure generally relate to wireless communication and specifically to techniques and apparatuses for applying a dynamic indication for subband full duplex.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a semi-static time and frequency configuration for subband full duplex (SBFD) operation in a symbol or slot pattern. The method may include receiving a dynamic indication that adds or updates one or more SBFD symbols or slots in the symbol or slot pattern. The method may include communicating based at least in part on the semi-static time and frequency configuration and one or more of the dynamic indication or a restriction rule that restricts application of the dynamic indication.

Some aspects described herein relate to a method of wireless communication performed by a network entity. The method may include transmitting a semi-static time and frequency configuration for SBFD operation in a symbol or slot pattern. The method may include transmitting a dynamic indication that adds or updates one or more SBFD symbols or slots in the symbol or slot pattern. The method may include communicating based at least in part on the semi-static time and frequency configuration and one or more of the dynamic indication or a restriction rule that restricts application of the dynamic indication.

Some aspects described herein relate to a UE for wireless communication. The UE may include one or more memories and one or more processors coupled to the one or more memories. The one or more processors may be individually or collectively configured to cause the UE to receive a semi-static time and frequency configuration for SBFD operation in a symbol or slot pattern. The one or more processors may be individually or collectively configured to cause the UE to receive a dynamic indication that adds or updates one or more SBFD symbols or slots in the symbol or slot pattern. The one or more processors may be individually or collectively configured to cause the UE to communicate based at least in part on the semi-static time and frequency configuration and one or more of the dynamic indication or a restriction rule that restricts application of the dynamic indication.

Some aspects described herein relate to a network entity for wireless communication. The network entity may include one or more memories and one or more processors coupled to the one or more memories. The one or more processors may be individually or collectively configured to cause the network entity to transmit a semi-static time and frequency configuration for SBFD operation in a symbol or slot pattern. The one or more processors may be individually or collectively configured to cause the network entity to transmit a dynamic indication that adds or updates one or more SBFD symbols or slots in the symbol or slot pattern. The one or more processors may be individually or collectively configured to cause the network entity to communicate based at least in part on the semi-static time and frequency configuration and one or more of the dynamic indication or a restriction rule that restricts application of the dynamic indication.

Some aspects described herein relate to a non-transitory computer-readable medium that stores a set of instructions for wireless communication by a UE. The set of instructions, when executed by one or more processors of the UE, may cause the UE to receive a semi-static time and frequency configuration for SBFD operation in a symbol or slot pattern. The set of instructions, when executed by one or more processors of the UE, may cause the UE to receive a dynamic indication that adds or updates one or more SBFD symbols or slots in the symbol or slot pattern. The set of instructions, when executed by one or more processors of the UE, may cause the UE to communicate based at least in part on the semi-static time and frequency configuration and one or more of the dynamic indication or a restriction rule that restricts application of the dynamic indication.

Some aspects described herein relate to a non-transitory computer-readable medium that stores a set of instructions for wireless communication by a network entity. The set of instructions, when executed by one or more processors of the network entity, may cause the network entity to transmit a semi-static time and frequency configuration for SBFD operation in a symbol or slot pattern. The set of instructions, when executed by one or more processors of the network entity, may cause the network entity to transmit a dynamic indication that adds or updates one or more SBFD symbols or slots in the symbol or slot pattern. The set of instructions, when executed by one or more processors of the network entity, may cause the network entity to communicate based at least in part on the semi-static time and frequency configuration and one or more of the dynamic indication or a restriction rule that restricts application of the dynamic indication.

Some aspects described herein relate to an apparatus for wireless communication. The apparatus may include means for receiving a semi-static time and frequency configuration for SBFD operation in a symbol or slot pattern. The apparatus may include means for receiving a dynamic indication that adds or updates one or more SBFD symbols or slots in the symbol or slot pattern. The apparatus may include means for communicating based at least in part on the semi-static time and frequency configuration and one or more of the dynamic indication or a restriction rule that restricts application of the dynamic indication.

Some aspects described herein relate to an apparatus for wireless communication. The apparatus may include means for transmitting a semi-static time and frequency configuration for SBFD operation in a symbol or slot pattern. The apparatus may include means for transmitting a dynamic indication that adds or updates one or more SBFD symbols or slots in the symbol or slot pattern. The apparatus may include means for communicating based at least in part on the semi-static time and frequency configuration and one or more of the dynamic indication or a restriction rule that restricts application of the dynamic indication.

Aspects generally include a method, apparatus, system, computer program product, non-transitory computer-readable medium, UE, base station, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full duplex communication, in accordance with the present disclosure.

FIG. 5 is a diagram illustrating an example of a slot pattern with subband full duplex (SBFD) slots, in accordance with the present disclosure.

FIG. 6 is a diagram illustrating examples of dynamic SBFD, in accordance with the present disclosure.

FIG. 7 is a diagram illustrating an example associated with using a restriction rule for a dynamic indication, in accordance with the present disclosure.

FIG. 8 is a diagram illustrating examples of restriction rules for symbol or slot regions, in accordance with the present disclosure.

FIG. 9 is a diagram illustrating an example process performed, for example, by a UE, in accordance with the present disclosure.

FIG. 10 is a diagram illustrating an example process performed, for example, by a network entity, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects relate generally to wireless communication and more particularly to full duplex (FD) transmissions. Some aspects more specifically relate to a user equipment (UE) operating in an in-band FD mode. In the in-band full duplex mode, the UE may transmit and receive on a same time and frequency resource. An uplink and a downlink may share the same time and frequency resource. Full duplex operations may include subband full duplex (SBFD) mode. The SBFD mode may also be referred to as a subband frequency division duplex mode or a flexible duplex mode. The wireless communication device may transmit and receive at a same time (in the same SBFD symbol or slot), but the wireless communication device may transmit and receive on different frequency domain resources.

A UE may transmit or receive communications using a configured symbol or slot pattern. The configured symbol or slot pattern may include a combination of downlink symbols or slots, uplink symbols or slots, or SBFD symbols or slots within a bandwidth part (BWP) for uplink (UL) and downlink (DL). The configuration may be semi-static. However, traffic and channel conditions may change, such that the semi-static configuration is not optimal. In some aspects, the UE may receive a dynamic indication that adds or updates one or more SBFD symbols or slots in the symbol or slot pattern. The UE may apply the dynamic indication by adding or updating one or more SBFD symbols or slots to a symbol or slot pattern of a semi-static configuration. For example, the dynamic indication may add an SBFD symbol or slot by converting a downlink symbol or slot to an SBFD symbol or slot. While dynamic indications may update a semi-static pattern, there may be times when an update or addition to the pattern may cause some communications to be delayed due to a transition time for switching or retuning antennas.

According to various aspects described herein, a UE may be configured with a restriction rule that specifies when and how a dynamic indication is to be applied to a semi-static time and frequency configuration for SBFD operation. For example, the restriction rule may limit for which symbols or slots that an SBFD can be added or updated (subtracted).

Particular aspects of the subject matter described in this disclosure can be implemented to realize one or more of the following potential advantages. In some examples, by restricting application of a dynamic indication for a semi-static configuration involving SBFD, the described techniques can be used to reduce latency caused by antenna transitions.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

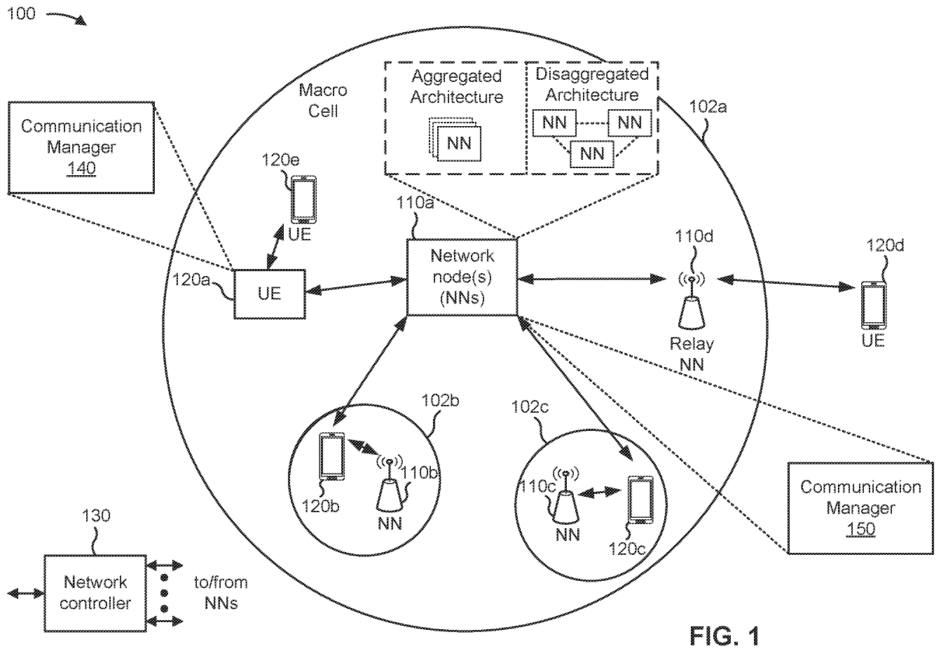

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive a semi-static time and frequency configuration for SBFD operation in a symbol or slot pattern. The communication manager 140 may receive a dynamic indication that adds or updates one or more SBFD symbols or slots in the symbol or slot pattern. The communication manager 140 may communicate based at least in part on the semi-static time and frequency configuration and one or more of the dynamic indication or a restriction rule that restricts application of the dynamic indication. Additionally, or alternatively, the communication manager 140 may perform one or more other operations described herein.

In some aspects, a network entity (e.g., a network node 110) may include a communication manager 150. As described in more detail elsewhere herein, the communication manager 150 may transmit a semi-static time and frequency configuration for SBFD operation in a symbol or slot pattern. The communication manager 150 may transmit a dynamic indication that adds or updates one or more SBFD symbols or slots in the symbol or slot pattern. The communication manager 150 may communicate based at least in part on the semi-static time and frequency configuration and one or more of the dynamic indication or a restriction rule that restricts application of the dynamic indication. Additionally, or alternatively, the communication manager 150 may perform one or more other operations described herein.

As indicated above, FIG. 1 is provided as an example. Other examples may differ from what is described with regard to FIG. 1.

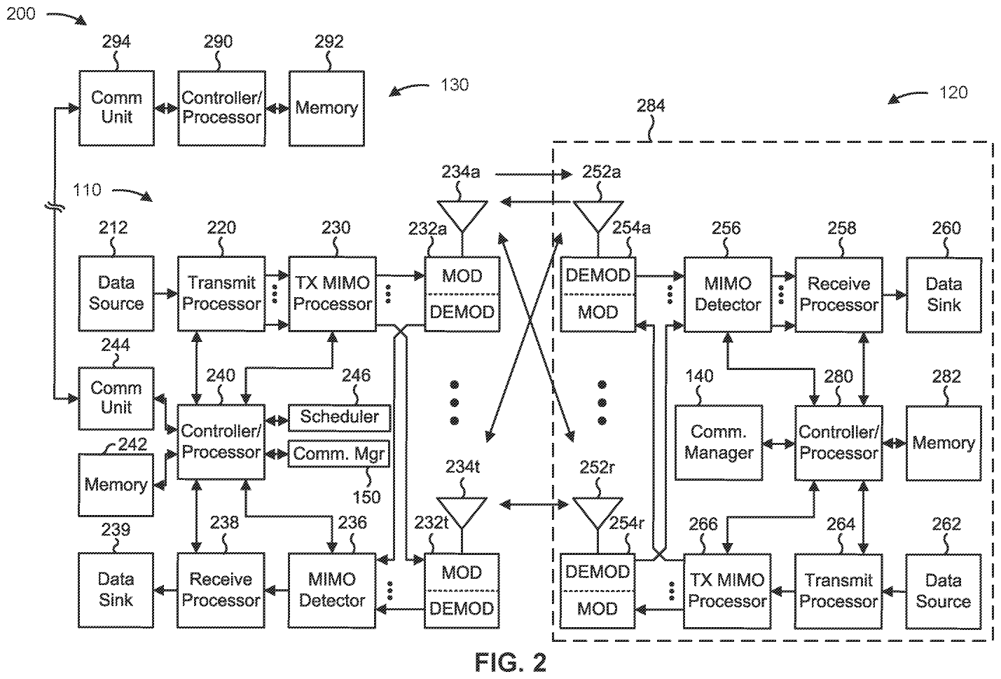

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

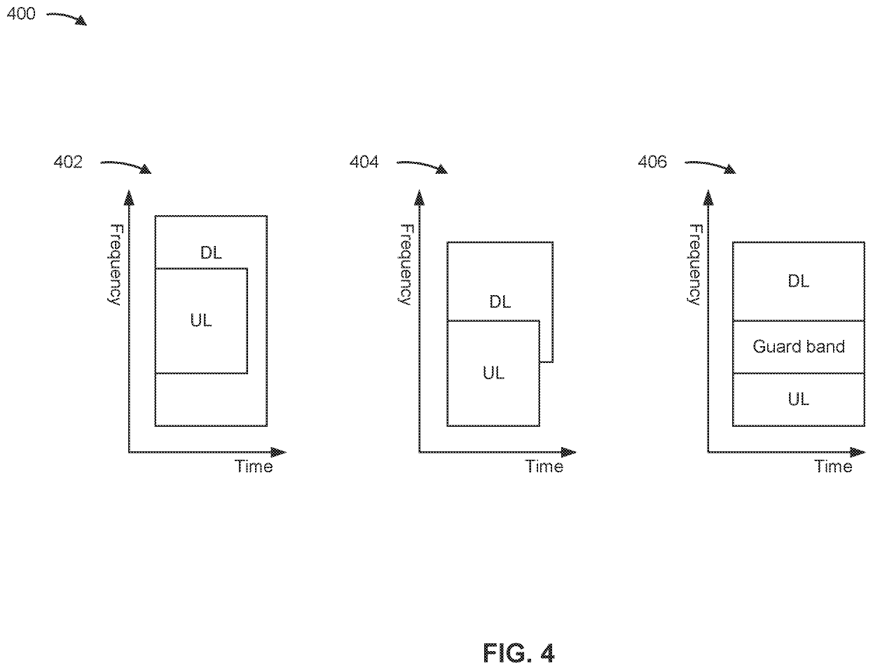

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

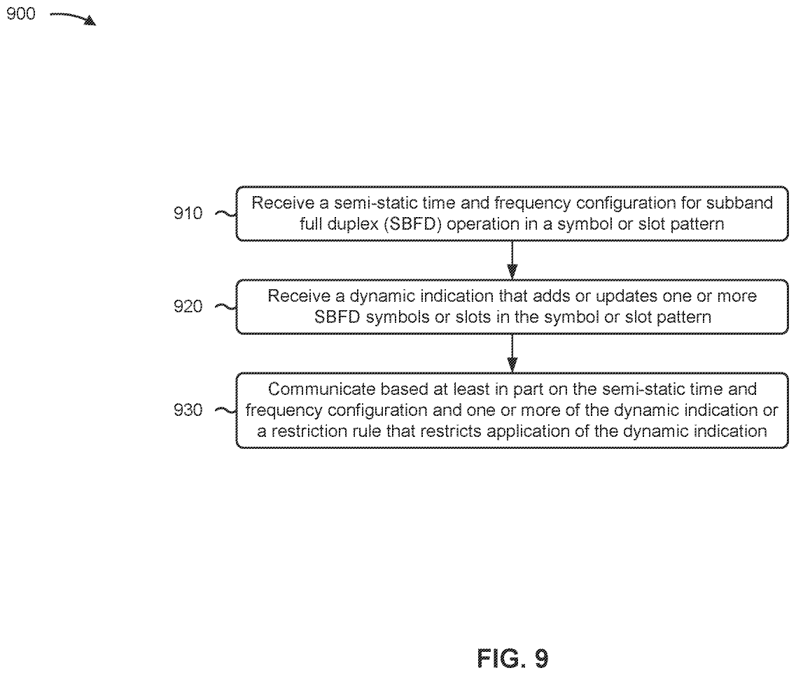

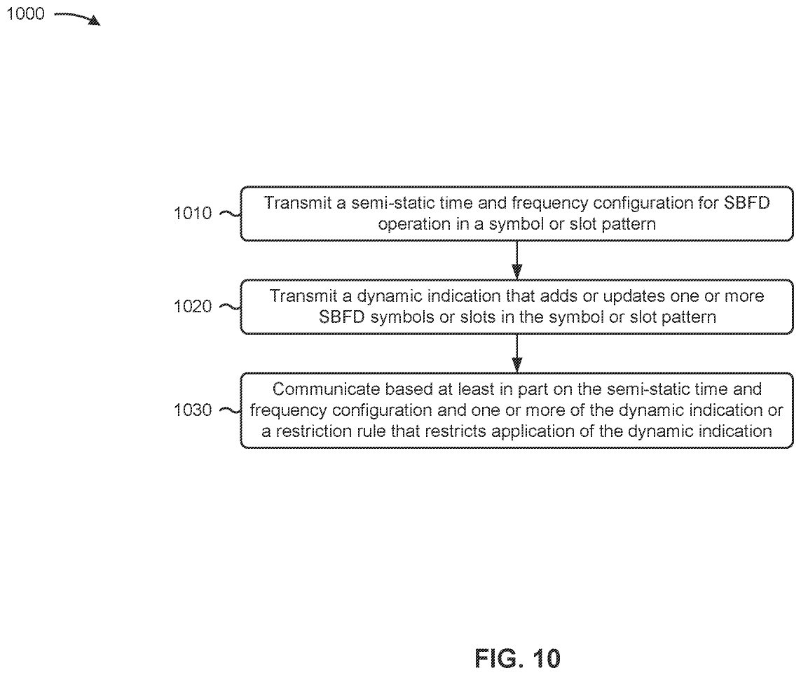

The controller/processor of a network entity (e.g., controller/processor 240 of the network node 110), the controller/processor 280 of the UE 120, or any other component(s) of FIG. 2 may perform one or more techniques associated with using a restriction rule when applying a dynamic indication that involves SBFD, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving a semi-static time and frequency configuration for SBFD operation in a symbol or slot pattern; means for receiving a dynamic indication that adds or updates one or more SBFD symbols or slots in the symbol or slot pattern; and/or means for communicating based at least in part on the semi-static time and frequency configuration and one or more of the dynamic indication or a restriction rule that restricts application of the dynamic indication. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110) includes means for transmitting a semi-static time and frequency configuration for SBFD operation in a symbol or slot pattern; means for transmitting a dynamic indication that adds or updates one or more SBFD symbols or slots in the symbol or slot pattern; and/or means for communicating based at least in part on the semi-static time and frequency configuration and one or more of the dynamic indication or a restriction rule that restricts application of the dynamic indication. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

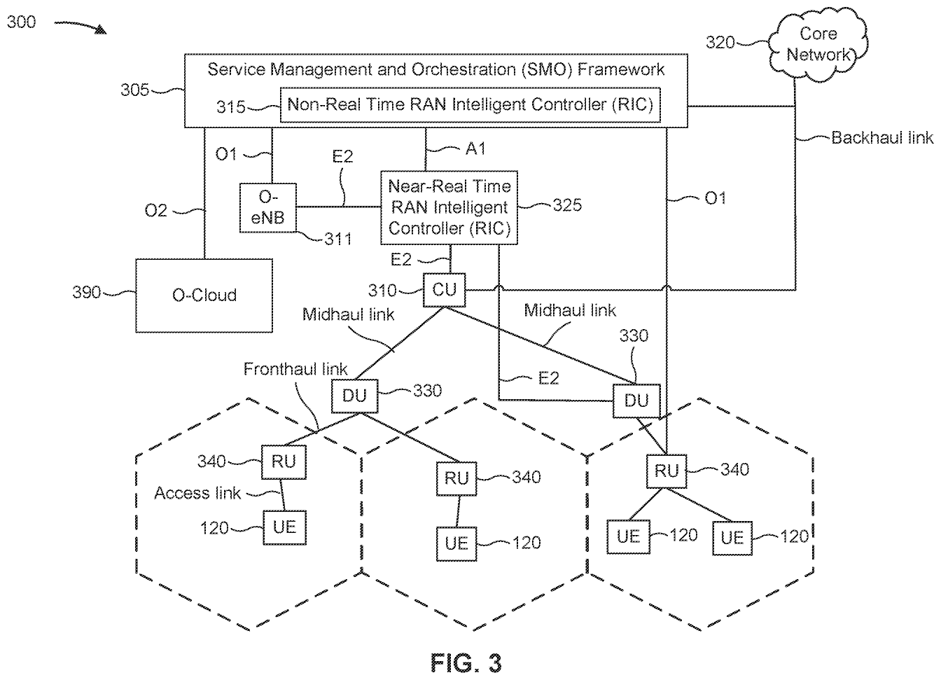

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (e.g., Central Unit—User Plane (CU-UP) functionality), control plane functionality (e.g., Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which may also be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based at least in part on a functional split (e.g., a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an AI interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as AI interface policies).

As indicated above, FIG. 3 is provided as an example. Other examples may differ from what is described with regard to FIG. 3.

FIG. 4 is a diagram illustrating examples of full duplex communication 400, in accordance with the present disclosure. In some cases, a wireless communication device (such as a UE or a network entity) may support full duplex operations. Full duplex operations may include the wireless communication device transmitting and receiving at approximately the same time.

A UE may operate in an in-band FD mode. In the in-band full duplex mode, the UE may transmit and receive on a same time and frequency resource. An uplink and a downlink may share the same time and frequency resource. For example, in a first full duplex communication 402, a time and frequency resource for the uplink may fully overlap with a time and frequency resource for the downlink. As another example, in a second full duplex communication 404, a time and frequency resource for the uplink may partially overlap with a time and frequency resource for the downlink.

Full duplex operations may include SBFD mode. The SBFD mode may also be referred to as a subband frequency division duplex mode or a flexible duplex mode. SBFD communication 406 shows that the wireless communication device may transmit and receive at a same time (in the same SBFD slot), but the wireless communication device may transmit and receive on different frequency domain resources. For example, a network entity may be operating in an SBFD mode. The network entity may schedule a first UE to receive a downlink communication in an SBFD slot. The network entity may schedule a second UE to transmit an uplink communication in the same SBFD slot. However, the uplink communication may cause interference for the first UE that is receiving the downlink communication. To address this, a downlink time/frequency resource in the SBFD slot may be separated (e.g., in time or frequency) from an uplink time/frequency resource in the SBFD slot by a gap, which may function to reduce self-interference and improve latency and uplink coverage. The gap may be a frequency offset or a frequency gap (guard band) between downlink time/frequency resources and uplink time/frequency resources in the same SBFD slot.

Uplink transmissions within an uplink subband may be allowed in the symbol. Uplink transmissions outside an uplink subband may not be allowed in the symbol. Frequency locations of downlink subband(s) may be known to an SBFD-aware UE. The frequency location of downlink subband(s) may be explicitly indicated or implicitly derived. Downlink receptions within downlink subband(s) may be allowed in the symbol. Uplink transmissions may be within an active uplink BWP and downlink receptions may be within an active downlink BWP in the symbol.

Full duplex and SBFD may increase the uplink duty cycle, which reduces latency and improves coverage. SBFD may enhance system capacity, resource utilization, and spectrum efficiency. SBFD may enable flexible and dynamic uplink/downlink resource adaption of traffic in a robust manner.

As indicated above, FIG. 4 is provided as an example. Other examples may differ from what is described with regard to FIG. 4.

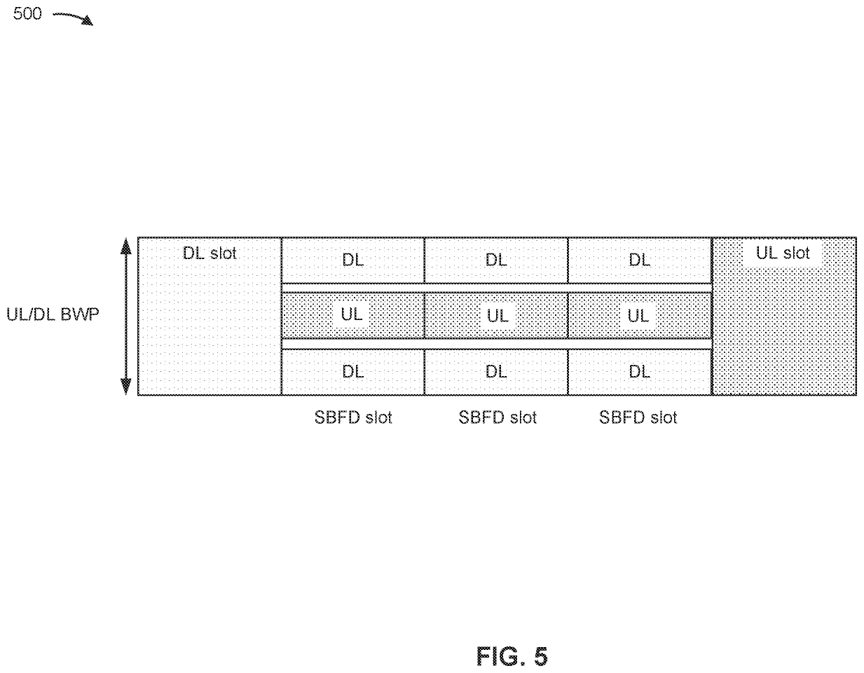

FIG. 5 is a diagram illustrating an example 500 of a slot pattern with SBFD slots, in accordance with the present disclosure.

A UE may transmit or receive communications using a configured symbol or slot pattern. The configured symbol or slot pattern may include a combination of downlink symbols or slots, uplink symbols or slots, or SBFD symbols or slots within a BWP for UL and DL. Example 500 shows SBFD slots (SBFD symbols in SBFD slots) that may be used for operation in an RRC connected state, where the UE maintains a connection that is established with RRC signaling. In some examples, the UE may be an SBFD-aware UE, where the time and frequency locations of subbands for SBFD operation are known to the SBFD-aware UE. In some examples, the UE may receive a semi-static time and frequency SBFD configuration for a symbol or slot pattern. The symbol or slot pattern may repeat. The UE may receive the configuration via RRC signaling. The configuration may be semi-static in that the UE maintains the configuration for communications until the UE receives an updated configuration.

As indicated above, FIG. 5 is provided as an example. Other examples may differ from what is described with regard to FIG. 5.

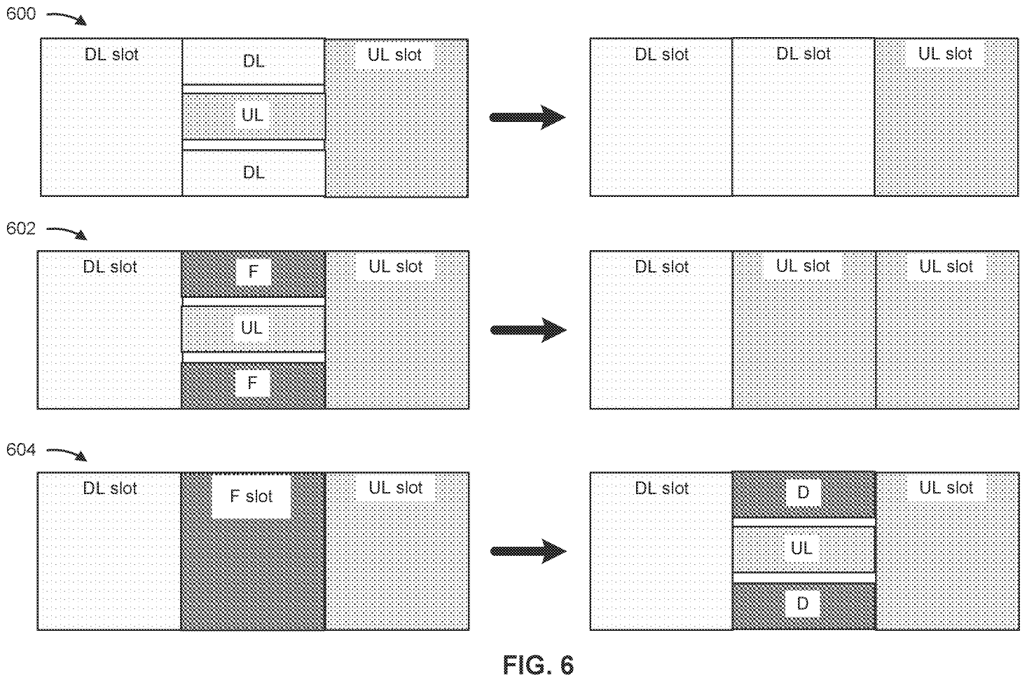

FIG. 6 is a diagram illustrating examples 600, 602, and 604 of dynamic SBFD, in accordance with the present disclosure.

A UE may be configured with a semi-static configuration. However, traffic and channel conditions may change, such that the semi-static configuration is not optimal. In some aspects, the UE may receive a dynamic indication that adds or updates one or more SBFD symbols or slots in the symbol or slot pattern. The UE may apply the dynamic indication. Applying the dynamic indication may include adding or updating one or more SBFD symbols or slots to a symbol or slot pattern of a semi-static configuration. For example, the dynamic indication may add an SBFD symbol or slot by converting a downlink symbol or slot to an SBFD symbol or slot. In this way, an uplink band may allow for uplink communications sooner or allow for more uplink communications sooner rather than waiting for the next uplink symbol or slot. In another example, the dynamic indication may update an SBFD symbol or slot by converting the SBFD symbol or slot to a downlink symbol or slot or an uplink symbol or slot. In this way, uplink or downlink communications may be increased or decreased. Latency may be reduced and throughput may be increased.

Example 600 shows application of a dynamic indication that updates (subtracts) an SBFD slot having two downlink subbands and an uplink subband. The dynamic indication may identify the SBFD slot in a slot pattern (e.g., by slot index) and indicate that the SBFD slot is to be a downlink slot (or a flexible slot). Example 602 shows application of a dynamic indication that updates an SBFD slot having two flexible subbands and an uplink subband. The dynamic indication may identify the SBFD slot and indicate that the SBFD slot is to be an uplink slot. Example 604 shows application of a dynamic indication that adds an SBFD slot by converting a flexible slot to an SBFD slot having two downlink subbands and an uplink subband.

In some aspects, a dynamic indication to add an SBFD symbol or slot may be included in a scheduling downlink control information (DCI) that schedules a communication and that is used to indicate whether the resource blocks (RBs) in a flexible subband are used for uplink transmission or downlink transmission. In some aspects, scheduling DCI to add an SBFD symbol or slot may be used to determine whether downlink receptions outside a semi-statically configured downlink subband and/or an uplink transmission outside a semi-statically configured uplink subband are allowed. In some aspects, non-scheduling DCI (that does not schedule data or is a group common DCI) may indicate whether a symbol or slot is an SBFD symbol or slot. In some aspects, the dynamic indication may include a slot format indicator (SFI). For example, a downlink symbol or slot in an SFI may update an SBFD symbol or slot to a downlink symbol or slot. An uplink symbol or slot in an SFI may update an SBFD symbol or slot to an uplink symbol or slot. In some aspects, a dynamic indication in a medium access control control element (MAC CE) may indicate whether a symbol or slot is an SBFD symbol or slot.

While dynamic indications may update a semi-static time and frequency pattern that can include SBFD symbols or slots, there may be times when an update or addition to a pattern may cause some communications to be delayed due to a transition time for switching or retuning antennas. Other dynamic indications may delay certain signals, such as synchronization signal block (SSB) symbols, tracking reference signal (TRS) symbols, aperiodic channel state information (CSI) reference signal (A-CSI-RS) symbols, control resource set (CORESET) symbols, semi-persistent scheduling (SPS) symbols, beam failure detection (BFD) symbols, or radio link management (RLM) symbols. If a dynamic indication is applied at an inappropriate time, latency is increased and/or throughput is decreased.

As indicated above, FIG. 6 is provided as an example. Other examples may differ from what is described with regard to FIG. 6.

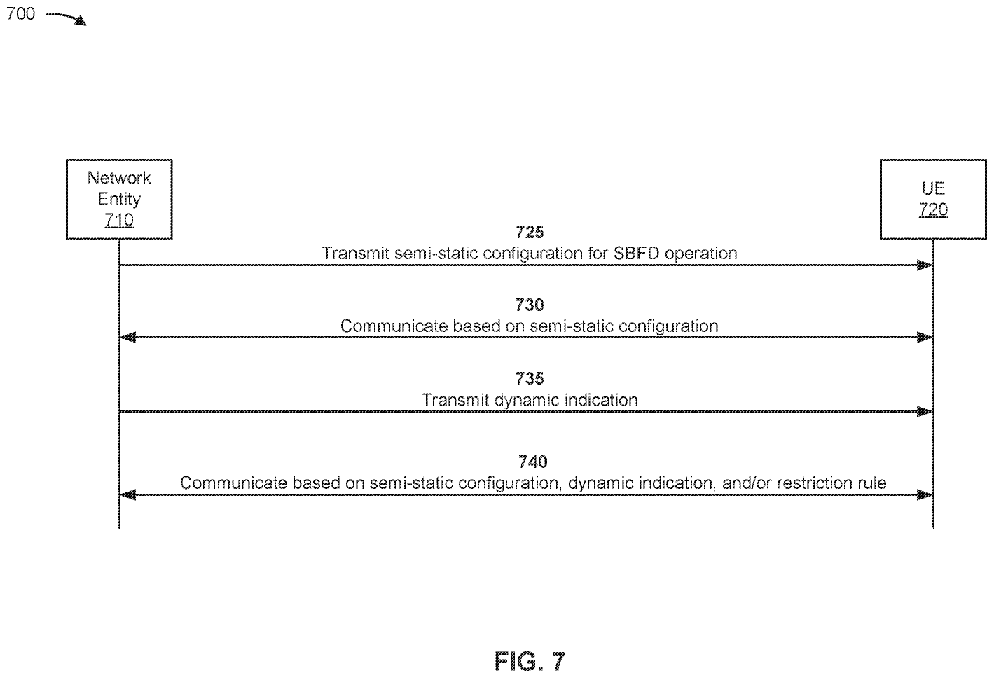

FIG. 7 is a diagram illustrating an example 700 associated with using a restriction rule for a dynamic indication, in accordance with the present disclosure. As shown in FIG. 7, a network entity (e.g., network node 110) and a UE 720 (e.g., a UE 120) may communicate with one another via a wireless network (e.g., wireless network 100).

According to various aspects described herein, a UE may be configured with a restriction rule that specifies when and how a dynamic indication is to be applied to a semi-static time and frequency configuration for SBFD operation. For example, the restriction rule may limit for which symbols or slots that an SBFD can be added or updated (subtracted). By restricting application of a dynamic indication, the UE may reduce latency caused by switching or retuning antennas too frequently when switching to and from SBFD slots or caused by delaying certain signaling.

Example 700 shows use of a restriction rule for application of a dynamic indication in a symbol or slot pattern configured with one or more SBFD symbols or slots. As shown by reference number 725, the network entity 710 may transmit a semi-static time and frequency configuration for SBFD operation. The configuration may indicate frequency bands for uplink or downlink in an SBFD slot. The configuration may indicate which symbols or slots are SBFD symbols or slots, which symbols or slots are downlink symbols or slots, which symbols or slots are uplink symbols or slots, and which symbols or slots are flexible symbols or slots. The SBFD operation may be for the network entity 710 (if the UE 720 operates in a half-duplex mode) or for both the network entity 710 and the UE 720 if the UE 720 also operates in a full-duplex mode (capable of SBFD). The UE 720 may be semi-statically configured with an uplink subband as an SBFD symbol or slot on a legacy downlink or flexible symbol or slot in time division duplexing (TDD) uplink/downlink common configuration (e.g., TDD-UL-DL-ConfigCommon). As shown by reference number 730, the network entity 710 and the UE 720 may communicate (transmit or receive communications) based at least in part on the semi-static configuration (symbol or slot pattern).

As shown by reference number 735, the network entity 710 may transmit a dynamic indication. The dynamic indication may be included in scheduling DCI, non-scheduling DCI, group common DCI, or a MAC CE. As shown by reference number 740, the network entity 710 and the UE 720 may communicate based at least in part on the semi-static configuration and the dynamic indication. The UE 720 may apply the dynamic indication to change one or more symbols or slots in the symbol or slot pattern. The change may involve adding or updating (subtracting) one or more SBFD symbols or slots in the symbol or slot pattern configured by the semi-static configuration. For example, the dynamic indication may update an SBFD symbol or slot (having an uplink subband and at least one downlink subband) by changing the SBFD symbol or slot to a downlink symbol or slot. The dynamic indication may update an SBFD symbol or slot (having an uplink subband and at least one flexible subband) by changing the SBFD symbol or slot to a flexible symbol or slot, a downlink symbol or slot, or an uplink symbol or slot. The dynamic indication may add an SBFD symbol or slot (having an uplink subband and at least one downlink subband) by changing a downlink symbol or slot, an uplink symbol or slot, or a flexible symbol or slot to the SBFD symbol or slot.

Also shown by reference number 740, the UE 720 may communicate further based at least in part on a restriction rule that restrict application of a dynamic indication. The network entity 710 may also communicate based at least in part on the restriction rule followed by the UE 720. The network entity 710 may transmit the restriction rule to the UE 720, or the UE 720 may obtain the restriction rule from stored configuration information (specified by a standard).

The restriction rule may restrict application of the dynamic indication to specific symbol or slot types. In some aspects, the restriction rule may specify that the one or more SBFD symbols or slots are able to be added at or updated to downlink symbols or slots and flexible symbols or slots. The UE 720 may expect the network entity 710 to dynamically add or subtract SBFD symbols or slots that are semi-statically configured on downlink symbols or slots or flexible symbols or slots.

In some aspects, the restriction rule may specify that the one or more SBFD symbols or slots are able to be added at or updated to flexible symbols or slots but not at downlink symbols or slots. The UE 720 may not expect the network entity 710 to dynamically add or subtract SBFD symbols or slots configured on downlink symbols or slots. The downlink symbols or slots may be static and protected from inter-UE cross-link interference (CLI). The restriction rule may also improve downlink throughput as the restriction rule may prevent a downlink slot from being converted to an SBFD slot. The restriction rule may help to maintain a quality of service (QoS).

In some aspects, the restriction rule may allow for the receipt of certain signaling that may otherwise be delayed by the dynamic indication. For example, the restriction rule may specify that the one or more SBFD symbols or slots are able to be added at or updated to flexible symbols or slots and downlink symbols or slots that are specified as non-restricted. Restricted downlink symbols or slots may include symbols or slots that carry SSB symbols, TRS symbols, A-CSI-RS symbols, CORESET symbols, SPS symbols, BFD symbols, RLM symbols, and/or other control or priority signaling. Non-restricted downlink symbols or slots may be symbols or slots that do not carry such signaling. The UE 720 may not expect the network entity 710 to dynamically add SBFD symbols or slots to semi-statically configured restricted downlink symbols or slots.

As indicated above, FIG. 7 is provided as an example. Other examples may differ from what is described with respect to FIG. 7.

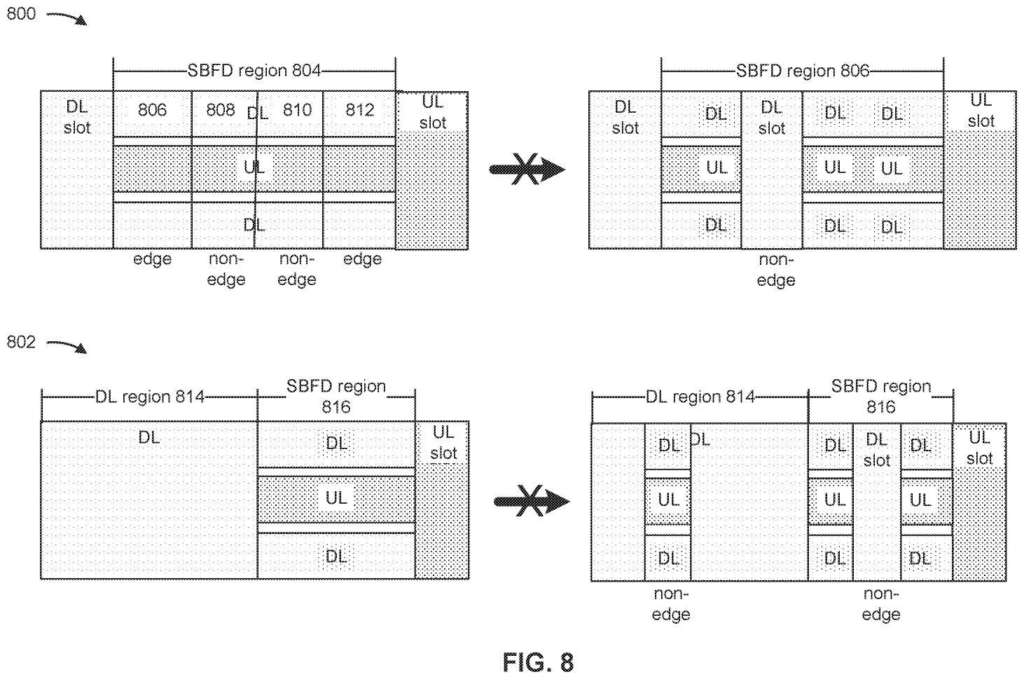

FIG. 8 is a diagram illustrating examples 800 and 802 of restriction rules for symbol or slot regions, in accordance with the present disclosure.

Example 800 shows an SBFD region 804 that includes multiple contiguous SBFD slots 806, 808, 810, and 812. Slots 806 and 812 are edge slots as slots 806 and 812 are at the edges or boundaries of the SBFD region 804. Slots 808 and 810 are non-edge slots that do not border other slots, such as a downlink slot or an uplink slot. Non-edge slots may be considered to be middle slots.

In some aspects, a restriction rule may restrict updates or additions to edge slots in symbol or slot regions. If a non-edge slot were to be updated, the UE 720 may be expected to retune its antennas multiple times in the region, which can cause delays. By restricting updates to edge slots, the UE 720 may be spared from multiple antenna transitions in within a region.

Example 800 shows that a restriction rule may prevent the conversion (update) of SBFD slot 808 to a downlink slot (or uplink or flexible slot) in the middle of the SBFD region 804. This restriction rule may help to enhance uplink coverage, as the UE 720 may not expect the network entity 170 to dynamically remove SBFD symbols or slots in the middle of the SBFD region 804, which adds more transition points between SBFD symbols or slots and non-SBFD symbols or slots. Transition points may reduce uplink coverage and increase overhead.

In some aspects, the UE 720 may also not expect the network entity 710 to dynamically add SBFD symbols on restricted downlink symbols in a downlink symbol or slot region (of multiple contiguous downlink symbols or slots). The restriction rule may also restrict the addition of SBFD symbols or slots to flexible regions (of multiple contiguous flexible symbols or slots) or to uplink regions (of multiple contiguous uplink slots). Example 802 shows that a restriction rule may prevent the conversion of a symbol or slot in a downlink region 814 (or flexible region or uplink region) to an SBFD symbol or slot. The restriction rule may also prevent a non-edge slot of an SBFD region 816 from being updated to another type of slot such as a downlink slot. By limiting transition points, the restriction rule may help to improve throughput by not wasting transmission/reception time on an additional transition.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120, UE 720) performs operations associated with using a restriction rule for dynamic indications involving SBFD.

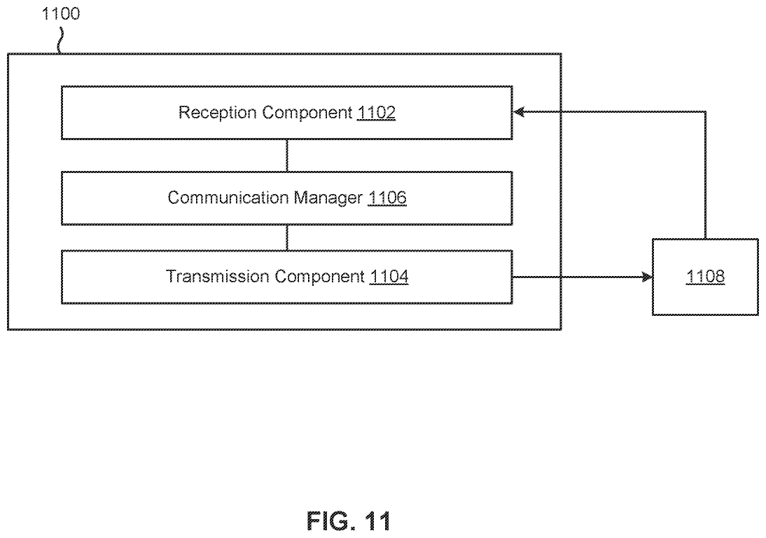

As shown in FIG. 9, in some aspects, process 900 may include receiving a semi-static time and frequency configuration for SBFD operation in a symbol or slot pattern (block 910). For example, the UE (e.g., using reception component 1102 and/or communication manager 1106, depicted in FIG. 11) may receive a semi-static time and frequency configuration for SBFD operation in a symbol or slot pattern, as described above.

As further shown in FIG. 9, in some aspects, process 900 may include receiving a dynamic indication that adds or updates one or more SBFD symbols or slots in the symbol or slot pattern (block 920). For example, the UE (e.g., using reception component 1102 and/or communication manager 1106, depicted in FIG. 11) may receive a dynamic indication that adds or updates one or more SBFD symbols or slots in the symbol or slot pattern, as described above.

As further shown in FIG. 9, in some aspects, process 900 may include communicating based at least in part on the semi-static time and frequency configuration and one or more of the dynamic indication or a restriction rule that restricts application of the dynamic indication (block 930). For example, the UE (e.g., using reception component 1102, transmission component 1104, and/or communication manager 1106, depicted in FIG. 11) may communicate based at least in part on the semi-static time and frequency configuration and one or more of the dynamic indication or a restriction rule that restricts application of the dynamic indication, as described above.

Process 900 may include additional aspects, such as any single aspect or any combination of aspects described below and/or in connection with one or more other processes described elsewhere herein.

In a first aspect, the semi-static time and frequency configuration indicates frequency bands for the SBFD operation, and the SBFD operation is for one or more of a network entity or the UE.

In a second aspect, alone or in combination with the first aspect, the dynamic indication updates an SBFD symbol or slot having an uplink subband and at least one downlink subband by changing the SBFD symbol or slot to a downlink symbol or slot.

In a third aspect, alone or in combination with one or more of the first and second aspects, the dynamic indication updates an SBFD symbol or slot having an uplink subband and at least one flexible subband by changing the SBFD symbol or slot to a flexible symbol or slot, a downlink symbol or slot, or an uplink symbol or slot.

In a fourth aspect, alone or in combination with one or more of the first through third aspects, the dynamic indication adds an SBFD symbol or slot having an uplink subband and at least one downlink subband by changing a downlink symbol or slot, an uplink symbol or slot, or a flexible symbol or slot to the SBFD symbol or slot.

In a fifth aspect, alone or in combination with one or more of the first through fourth aspects, the communicating is based at least in part on the semi-static time and frequency configuration, the dynamic indication, and the restriction rule.

In a sixth aspect, alone or in combination with one or more of the first through fifth aspects, process 900 includes receiving an indication of the restriction rule or obtaining the restriction rule from stored configuration information.

In a seventh aspect, alone or in combination with one or more of the first through sixth aspects, the restriction rule specifies that the one or more SBFD symbols or slots are able to be added at or updated to downlink symbols or slots and flexible symbols or slots.

In an eighth aspect, alone or in combination with one or more of the first through seventh aspects, the restriction rule specifies that the one or more SBFD symbols or slots are able to be added at or updated to flexible symbols or slots and not downlink symbols or slots.

In a ninth aspect, alone or in combination with one or more of the first through eighth aspects, the restriction rule specifies that the one or more SBFD symbols or slots are able to be added at or updated to flexible symbols or slots and downlink symbols or slots that are specified as non-restricted.

In a tenth aspect, alone or in combination with one or more of the first through ninth aspects, downlinking symbols or slots that are restricted include downlink symbols or slots for SSB symbols, TRS symbols, or A-CSI-RS symbols.

In an eleventh aspect, alone or in combination with one or more of the first through tenth aspects, downlinking symbols or slots that are restricted include downlink symbols or slots for CORESET symbols.

In a twelfth aspect, alone or in combination with one or more of the first through eleventh aspects, downlinking symbols or slots that are restricted include downlink symbols or slots for SPS symbols.

In a thirteenth aspect, alone or in combination with one or more of the first through twelfth aspects, downlinking symbols or slots that are restricted include downlink symbols or slots for BFD symbols or RLM symbols.

In a fourteenth aspect, alone or in combination with one or more of the first through thirteenth aspects, the restriction rule specifies that the one or more SBFD symbols or slots are able to be added or updated at non-edge slots of a downlink region of three or more contiguous downlink slots.

In a fifteenth aspect, alone or in combination with one or more of the first through fourteenth aspects, the restriction rule specifies that the one or more SBFD symbols or slots are not able to be added or updated at non-edge slots of a flexible region of three or more contiguous flexible slots.

In a sixteenth aspect, alone or in combination with one or more of the first through fifteenth aspects, the restriction rule specifies that the one or more SBFD symbols or slots are not able to be added or updated at non-edge slots of an SBFD region of three or more SBFD slots.

In a seventeenth aspect, alone or in combination with one or more of the first through sixteenth aspects, the dynamic indication is included in scheduling DCI.

In an eighteenth aspect, alone or in combination with one or more of the first through seventeenth aspects, the dynamic indication is included in non-scheduling DCI that does not schedule data.

In a nineteenth aspect, alone or in combination with one or more of the first through eighteenth aspects, the dynamic indication is included in non-scheduling DCI that is a group common DCI.

In a twentieth aspect, alone or in combination with one or more of the first through nineteenth aspects, the dynamic indication is included in a medium access control control element (MAC CE).

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., network node 110, network entity 710) performs operations associated with a restriction rule for a dynamic indication involving SBFD.

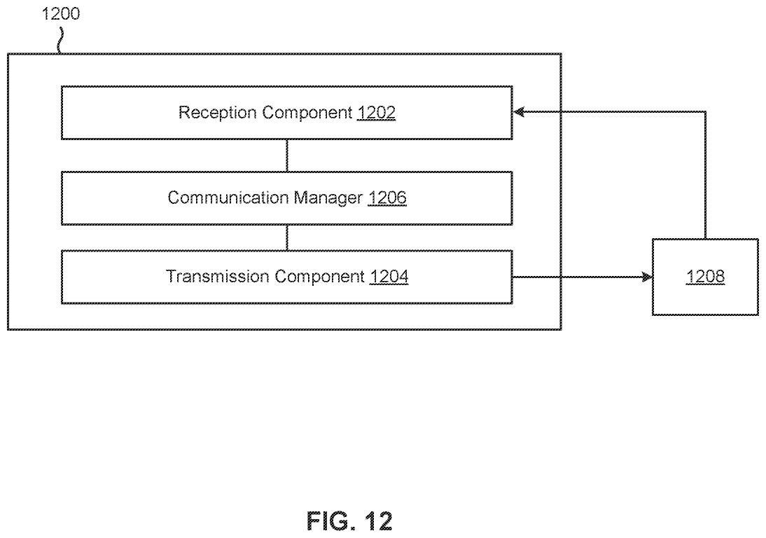

As shown in FIG. 10, in some aspects, process 1000 may include transmitting a semi-static time and frequency configuration for SBFD operation in a symbol or slot pattern (block 1010). For example, the network entity (e.g., using transmission component 1204 and/or communication manager 1206, depicted in FIG. 12) may transmit a semi-static time and frequency configuration for SBFD operation in a symbol or slot pattern, as described above.

As further shown in FIG. 10, in some aspects, process 1000 may include transmitting a dynamic indication that adds or updates one or more SBFD symbols or slots in the symbol or slot pattern (block 1020). For example, the network entity (e.g., using transmission component 1204 and/or communication manager 1206, depicted in FIG. 12) may transmit a dynamic indication that adds or updates one or more SBFD symbols or slots in the symbol or slot pattern, as described above.

As further shown in FIG. 10, in some aspects, process 1000 may include communicating based at least in part on the semi-static time and frequency configuration and one or more of the dynamic indication or a restriction rule that restricts application of the dynamic indication (block 1030). For example, the network entity (e.g., using reception component 1202, transmission component 1204, and/or communication manager 1206, depicted in FIG. 12) may communicate based at least in part on the semi-static time and frequency configuration and one or more of the dynamic indication or a restriction rule that restricts application of the dynamic indication, as described above.

Process 1000 may include additional aspects, such as any single aspect or any combination of aspects described below and/or in connection with one or more other processes described elsewhere herein.

In a first aspect, the communicating is based at least in part on the semi-static time and frequency configuration, the dynamic indication, and the restriction rule.

In a second aspect, alone or in combination with the first aspect, process 1000 includes transmitting an indication of the restriction rule.

In a third aspect, alone or in combination with one or more of the first and second aspects, the restriction rule specifies that the one or more SBFD symbols or slots are able to be added at or updated to downlink symbols or slots and flexible symbols or slots.

In a fourth aspect, alone or in combination with one or more of the first through third aspects, the restriction rule specifies that the one or more SBFD symbols or slots are able to be added at or updated to flexible symbols or slots and not downlink symbols or slots.

In a fifth aspect, alone or in combination with one or more of the first through fourth aspects, the restriction rule specifies that the one or more SBFD symbols or slots are able to be added at or updated to flexible symbols or slots and downlink symbols or slots that are specified as non-restricted.

In a sixth aspect, alone or in combination with one or more of the first through fifth aspects, the restriction rule specifies that the one or more SBFD symbols or slots are able to be added or updated at non-edge slots of a downlink region of three or more contiguous downlink slots.

In a seventh aspect, alone or in combination with one or more of the first through sixth aspects, the restriction rule specifies that the one or more SBFD symbols or slots are not able to be added or updated at non-edge slots of a flexible region of three or more contiguous flexible slots.

In an eighth aspect, alone or in combination with one or more of the first through seventh aspects, the restriction rule specifies that the one or more SBFD symbols or slots are not able to be added or updated at non-edge slots of an SBFD region of three or more SBFD slots.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE (e.g., UE 120, UE 720), or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 1-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a semi-static time and frequency configuration for SBFD operation in a symbol or slot pattern. The reception component 1102 may receive a dynamic indication that adds or updates one or more SBFD symbols or slots in the symbol or slot pattern. The reception component 1102 and/or the transmission component 1104 may communicate based at least in part on the semi-static time and frequency configuration and one or more of the dynamic indication or a restriction rule that restricts application of the dynamic indication.

The reception component 1102 may receive an indication of the restriction rule or obtaining the restriction rule from stored configuration information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network entity (e.g., network node 110, network entity 710), or a network entity may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 1-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network entity described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network entity described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit a semi-static time and frequency configuration for SBFD operation in a symbol or slot pattern. The transmission component 1204 may transmit a dynamic indication that adds or updates one or more SBFD symbols or slots in the symbol or slot pattern. The reception component 1202 and/or the transmission component 1204 may communicate based at least in part on the semi-static time and frequency configuration and one or more of the dynamic indication or a restriction rule that restricts application of the dynamic indication. The transmission component 1204 may transmit an indication of the restriction rule.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: receiving a semi-static time and frequency configuration for subband full duplex (SBFD) operation in a symbol or slot pattern; receiving a dynamic indication that adds or updates one or more SBFD symbols or slots in the symbol or slot pattern; and communicating based at least in part on the semi-static time and frequency configuration and one or more of the dynamic indication or a restriction rule that restricts application of the dynamic indication.
Aspect 2: The method of Aspect 1, wherein the semi-static time and frequency configuration indicates frequency bands for the SBFD operation, and wherein the SBFD operation is for one or more of a network entity or the UE.
Aspect 3: The method of any of Aspects 1-2, wherein the dynamic indication updates an SBFD symbol or slot having an uplink subband and at least one downlink subband by changing the SBFD symbol or slot to a downlink symbol or slot.
Aspect 4: The method of any of Aspects 1-3, wherein the dynamic indication updates an SBFD symbol or slot having an uplink subband and at least one flexible subband by changing the SBFD symbol or slot to a flexible symbol or slot, a downlink symbol or slot, or an uplink symbol or slot.
Aspect 5: The method of any of Aspects 1-4, wherein the dynamic indication adds an SBFD symbol or slot having an uplink subband and at least one downlink subband by changing a downlink symbol or slot, an uplink symbol or slot, or a flexible symbol or slot to the SBFD symbol or slot.
Aspect 6: The method of any of Aspects 1-5, wherein the communicating is based at least in part on the semi-static time and frequency configuration, the dynamic indication, and the restriction rule.
Aspect 7: The method of any of Aspects 1-6, further comprising receiving an indication of the restriction rule or obtaining the restriction rule from stored configuration information.
Aspect 8: The method of any of Aspects 1-7, wherein the restriction rule specifies that the one or more SBFD symbols or slots are able to be added at or updated to downlink symbols or slots and flexible symbols or slots.
Aspect 9: The method of any of Aspects 1-8, wherein the restriction rule specifies that the one or more SBFD symbols or slots are able to be added at or updated to flexible symbols or slots and not downlink symbols or slots.
Aspect 10: The method of any of Aspects 1-9, wherein the restriction rule specifies that the one or more SBFD symbols or slots are able to be added at or updated to flexible symbols or slots and downlink symbols or slots that are specified as non-restricted.
Aspect 11: The method of Aspect 10, wherein downlink symbols or slots that are restricted include downlink symbols or slots for synchronization signal block symbols, tracking reference signal symbols, or aperiodic channel state information reference signal symbols.
Aspect 12: The method of Aspect 10, wherein downlink symbols or slots that are restricted include downlink symbols or slots for control resource set symbols.
Aspect 13: The method of Aspect 10, wherein downlink symbols or slots that are restricted include downlink symbols or slots for semi-persistent scheduling symbols.
Aspect 14: The method of Aspect 10, wherein downlink symbols or slots that are restricted include downlink symbols or slots for beam failure detection symbols or radio link management symbols.
Aspect 15: The method of any of Aspects 1-14, wherein the restriction rule specifies that the one or more SBFD symbols or slots are able to be added or updated at non-edge slots of a downlink region of three or more contiguous downlink slots.
Aspect 16: The method of any of Aspects 1-15, wherein the restriction rule specifies that the one or more SBFD symbols or slots are not able to be added or updated at non-edge slots of a flexible region of three or more contiguous flexible slots.
Aspect 17: The method of any of Aspects 1-16, wherein the restriction rule specifies that the one or more SBFD symbols or slots are not able to be added or updated at non-edge slots of an SBFD region of three or more SBFD slots.
Aspect 18: The method of any of Aspects 1-17, wherein the dynamic indication is included in scheduling downlink control information.
Aspect 19: The method of any of Aspects 1-18, wherein the dynamic indication is included in non-scheduling downlink control information that does not schedule data.
Aspect 20: The method of any of Aspects 1-19, wherein the dynamic indication is included in non-scheduling downlink control information (DCI) that is a group common DCI.
Aspect 21: The method of any of Aspects 1-20, wherein the dynamic indication is included in a medium access control control element (MAC CE).
Aspect 22: A method of wireless communication performed by a network entity, comprising: transmitting a semi-static time and frequency configuration for subband full duplex (SBFD) operation in a symbol or slot pattern; transmitting a dynamic indication that adds or updates one or more SBFD symbols or slots in the symbol or slot pattern; and communicating based at least in part on the semi-static time and frequency configuration and one or more of the dynamic indication or a restriction rule that restricts application of the dynamic indication.
Aspect 23: The method of Aspect 22, wherein the communicating is based at least in part on the semi-static time and frequency configuration, the dynamic indication, and the restriction rule.
Aspect 24: The method of any of Aspects 22-23, further comprising transmitting an indication of the restriction rule.
Aspect 25: The method of any of Aspects 22-24, wherein the restriction rule specifies that the one or more SBFD symbols or slots are able to be added at or updated to downlink symbols or slots and flexible symbols or slots.
Aspect 26: The method of any of Aspects 22-25, wherein the restriction rule specifies that the one or more SBFD symbols or slots are able to be added at or updated to flexible symbols or slots and not downlink symbols or slots.
Aspect 27: The method of any of Aspects 22-26, wherein the restriction rule specifies that the one or more SBFD symbols or slots are able to be added at or updated to flexible symbols or slots and downlink symbols or slots that are specified as non-restricted.
Aspect 28: The method of any of Aspects 22-27, wherein the restriction rule specifies that the one or more SBFD symbols or slots are able to be added or updated at non-edge slots of a downlink region of three or more contiguous downlink slots.
Aspect 29: The method of any of Aspects 22-28, wherein the restriction rule specifies that the one or more SBFD symbols or slots are not able to be added or updated at non-edge slots of a flexible region of three or more contiguous flexible slots.
Aspect 30: The method of any of Aspects 22-29, wherein the restriction rule specifies that the one or more SBFD symbols or slots are not able to be added or updated at non-edge slots of an SBFD region of three or more SBFD slots.
Aspect 31: An apparatus for wireless communication at a device, comprising a processor; memory coupled with the processor; and instructions stored in the memory and executable by the processor to cause the apparatus to perform the method of one or more of Aspects 1-30.
Aspect 32: A device for wireless communication, comprising a memory and one or more processors coupled to the memory, the one or more processors configured to perform the method of one or more of Aspects 1-30.
Aspect 33: An apparatus for wireless communication, comprising at least one means for performing the method of one or more of Aspects 1-30.
Aspect 34: A non-transitory computer-readable medium storing code for wireless communication, the code comprising instructions executable by a processor to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, individually or collectively configured to cause the UE to:
receive a semi-static time and frequency configuration for subband full duplex (SBFD) operation in a symbol or slot pattern;
receive a dynamic indication that adds or updates one or more SBFD symbols or slots in the symbol or slot pattern; and
communicate based at least in part on the semi-static time and frequency configuration and one or more of the dynamic indication or a restriction rule that restricts application of the dynamic indication.

2. The UE of claim 1, wherein the semi-static time and frequency configuration indicates frequency bands for the SBFD operation, and wherein the SBFD operation is for one or more of a network entity or the UE.

3. The UE of claim 1, wherein the dynamic indication updates an SBFD symbol or slot having an uplink subband and at least one downlink subband by changing the SBFD symbol or slot to a downlink symbol or slot.

4. The UE of claim 1, wherein the dynamic indication updates an SBFD symbol or slot having an uplink subband and at least one flexible subband by changing the SBFD symbol or slot to a flexible symbol or slot, a downlink symbol or slot, or an uplink symbol or slot.

5. The UE of claim 1, wherein the dynamic indication adds an SBFD symbol or slot having an uplink subband and at least one downlink subband by changing a downlink symbol or slot, an uplink symbol or slot, or a flexible symbol or slot to the SBFD symbol or slot.

6. The UE of claim 1, wherein the one or more processors are individually or collectively configured to cause the UE to communicate based at least in part on the semi-static time and frequency configuration, the dynamic indication, and the restriction rule.

7. The UE of claim 1, wherein the one or more processors are individually or collectively configured to cause the UE to receive an indication of the restriction rule or obtaining the restriction rule from stored configuration information.

8. The UE of claim 1, wherein the restriction rule specifies that the one or more SBFD symbols or slots are able to be added at or updated to downlink symbols or slots and flexible symbols or slots.

9. The UE of claim 1, wherein the restriction rule specifies that the one or more SBFD symbols or slots are able to be added at or updated to flexible symbols or slots and not downlink symbols or slots.

10. The UE of claim 1, wherein the restriction rule specifies that the one or more SBFD symbols or slots are able to be added at or updated to flexible symbols or slots and downlink symbols or slots that are specified as non-restricted.

11. The UE of claim 10, wherein the one or more processors, to downlink symbols or slots that are restricted, are configured to downlink symbols or slots for synchronization signal block symbols, tracking reference signal symbols, or aperiodic channel state information reference signal symbols.

12. The UE of claim 10, wherein the one or more processors, to downlink symbols or slots that are restricted, are configured to downlink symbols or slots for control resource set symbols.

13. The UE of claim 10, wherein the one or more processors, to downlink symbols or slots that are restricted, are configured to downlink symbols or slots for semi-persistent scheduling symbols.

14. The UE of claim 10, wherein the one or more processors, to downlink symbols or slots that are restricted, are configured to downlink symbols or slots for beam failure detection symbols or radio link management symbols.

15. The UE of claim 1, wherein the restriction rule specifies that the one or more SBFD symbols or slots are able to be added or updated at non-edge slots of a downlink region of three or more contiguous downlink slots.

16. The UE of claim 1, wherein the restriction rule specifies that the one or more SBFD symbols or slots are not able to be added or updated at non-edge slots of a flexible region of three or more contiguous flexible slots.

17. The UE of claim 1, wherein the restriction rule specifies that the one or more SBFD symbols or slots are not able to be added or updated at non-edge slots of an SBFD region of three or more SBFD slots.

18. The UE of claim 1, wherein the dynamic indication is included in scheduling downlink control information.

19. The UE of claim 1, wherein the dynamic indication is included in non-scheduling downlink control information that does not schedule data.

20. The UE of claim 1, wherein the dynamic indication is included in non-scheduling downlink control information (DCI) that is a group common DCI.

21. The UE of claim 1, wherein the dynamic indication is included in a medium access control control element (MAC CE).

22. A network entity for wireless communication, comprising:
one or more memories; and
one or more processors, coupled to the one or more memories, individually or collectively configured to cause the network entity to:
transmit a semi-static time and frequency configuration for subband full duplex (SBFD) operation in a symbol or slot pattern;
transmit a dynamic indication that adds or updates one or more SBFD symbols or slots in the symbol or slot pattern; and
communicate based at least in part on the semi-static time and frequency configuration and one or more of the dynamic indication or a restriction rule that restricts application of the dynamic indication.

23. The network entity of claim 22, wherein the communicating is based at least in part on the semi-static time and frequency configuration, the dynamic indication, and the restriction rule.

24. The network entity of claim 22, wherein the one or more processors are individually or collectively configured to cause the network entity to transmit an indication of the restriction rule.

25. The network entity of claim 22, wherein the restriction rule specifies that the one or more SBFD symbols or slots are able to be added at or converted to downlink symbols or slots and flexible symbols or slots.

26. The network entity of claim 22, wherein the restriction rule specifies that the one or more SBFD symbols or slots are able to be added at or converted to flexible symbols or slots and not downlink symbols or slots.

27. The network entity of claim 22, wherein the restriction rule specifies that the one or more SBFD symbols or slots are able to be added at or converted to flexible symbols or slots and downlink symbols or slots that are specified as non-restricted.

28. The network entity of claim 22, wherein the restriction rule specifies that the one or more SBFD symbols or slots are able to be added or updated at non-edge slots of a downlink region of three or more contiguous downlink slots.

29. The network entity of claim 22, wherein the restriction rule specifies that the one or more SBFD symbols or slots are not able to be added or updated at non-edge slots of a flexible region of three or more contiguous flexible slots.

30. The network entity of claim 22, wherein the restriction rule specifies that the one or more SBFD symbols or slots are not able to be added or updated at non-edge slots of an SBFD region of three or more SBFD slots.
